(19) United States
(12) Patent Application Publication
(10) Pub. No.: US 2023/0380503 A1
(43) Pub. Date: Nov. 30, 2023

(54) AEROSOL PROVISION DEVICE

(71) Applicant: Nicoventures Trading Limited, LONDON (GB)

(72) Inventors: Daniel LOCHTMAN, London (GB); David BUREAU, London (GB); James SHERIDAN, London (GB)

(21) Appl. No.: 18/248,326

(22) PCT Filed: Oct. 15, 2021
(86) PCT No.: PCT/EP2021/078685

§ 371 Date: Apr. 7, 2023

(30) Foreign Application Priority Data
Oct. 16, 2020 (GB) 2016476.0

(51) Int. Cl. A24F 40/465; A24F 40/20; A24F 40/51; H05B 6/10

(52) U.S. Cl. CPC A24F 40/465; A24F 40/20; A24F 40/51; H05B 6/105

(57) ABSTRACT

An aerosol provision device and related methods of using the device where the device includes a device housing defining a chamber and a heater assembly. The assembly includes a receptacle defining a heating chamber arranged to removably receive at least a portion of an article having aerosol generating material, and a heating element for heating at least a portion of an article having aerosol generating material received in the heating chamber. The receptacle is removably disposed within the device housing chamber and is configured such that rotation of the receptacle relative to the device housing allows it to be engaged or disengaged with the device housing. A system and a kit of parts can include the device.

### PRIORITY CLAIM

The present application is a National Phase entry of PCT Application No. PCT/EP2021/078685, filed Oct. 15, 2021, which claims priority from GB Application No. 2016476.0, filed Oct. 16, 2020, each of which is hereby fully incorporated herein by reference.

### TECHNICAL FIELD

The present invention relates to an aerosol provision device. The present invention also relates to an aerosol provision system comprising the aerosol provision device and an article comprising aerosol generating material, a kit of parts including the aerosol provision device and a method of using the aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device. The device comprises a device housing defining a device chamber and a heater assembly. The heater assembly comprises a receptacle defining a heating chamber arranged to removably receive at least a portion of an article comprising aerosol generating material, and a heating element for heating at least a portion of an article comprising aerosol generating material received in the heating chamber. The receptacle is at least partially removably disposed within the device chamber and is configured such that rotation of the receptacle relative to the device housing allows it to be engaged with the device housing.

In an embodiment of the above, the device housing and the receptacle comprise complementary interlocking features that are configured to engage in response to rotation of the receptacle relative to the device housing.

In further embodiment of the above, the complementary interlocking features comprise a first groove disposed on one of the device housing and the receptacle and a protrusion disposed on the other one of the device housing and the receptacle. The receptacle being configured to engage with the device housing by the rotation placing the protrusion into alignment with the first groove, and to disengage from the device housing by the rotation placing the protrusion out of alignment with the first groove.

In yet a further embodiment of the above, the complementary interlocking features further comprise a second groove on one of the device housing and the receptacle. The receptacle being configured to engage with the device housing by the rotation moving the protrusion out of alignment with the second groove and into alignment with the first groove, and to disengage from the device housing by the rotation moving the protrusion out of alignment with the first groove and into alignment with the second groove. The second groove may extend axially along the longitudinal axis of one of the receptacle and the device chamber.

In an alternative embodiment, the complementary interlocking features are instead threaded portions defined on the device housing and the receptacle.

In another alternative embodiment, the complementary interlocking features form a bayonet mount.

In a further embodiment of any of the above, the device further comprises a biasing member that is configured to be compressed in response to insertion of the receptacle into the device housing chamber to provide a biasing force that opposes the insertion.

In a further embodiment of any of the above, the receptacle defines a base, and the heating element protrudes from the base.

In a further embodiment of any of the above, the heating element is supported by the receptacle such that the heating element is removable from the device housing by removal of the receptacle from the device housing. Alternatively, the heating element is supported by the device housing such that the heating element remains in the device housing following removal of the receptacle from the device housing.

In a further embodiment of any of the above, the heating element is separable from each of the device housing and the receptacle.

In a further embodiment, the device further comprises a thermocouple in the device housing that is configured to be in removable thermal communication with the heating element when the heating element is disposed in the device chamber.

In a further embodiment, the device further comprises an intermediate member positioned such that the heating element is placed into removable thermal communication with the thermocouple via the intermediate member when the heating element is disposed in the device chamber.

In a further embodiment of the above, the receptacle includes the intermediate member, and the intermediate member is in fixed thermal communication with the heating element and removable thermal communication with the thermocouple in response to insertion of the receptacle into engagement with the device housing. Alternatively, the intermediate member is positioned in the device housing and is in fixed thermal communication with the thermocouple and removable thermal communication with the heating element when the heating element is disposed in the device chamber.

In a further embodiment of any of the above, the heating element is a susceptor and the device further comprises an inductor coil for generating a varying magnetic field that penetrates the heating element.

In a further embodiment of any of the above, the receptacle comprises at least one engaging feature for insertion of a tool therein to aid rotation and removal of the receptacle from the device housing.

According to another aspect of the present disclosure, there is provided an aerosol provision system. The system comprises the aerosol provision device according to the above aspect or any of its embodiments, and an article comprising aerosol generating material, wherein the article is dimensioned to be at least partially received within the heater assembly.

According to another aspect of the present disclosure, there is provided a kit of parts. The kit of parts comprises the aerosol provision device according to the above discussed aspect or any of its embodiments, and a tool for insertion into the receptacle.

In an embodiment, the tool comprises a first set of prongs for engagement with the engaging feature and a second set of prongs for insertion into the heating chamber.

In a further embodiment, the second set of prongs comprise flared tips.

In yet a further embodiment, the first and second set of prongs are concentric with each other.

In a further embodiment of any of the above, the kit of parts further comprises an article comprising aerosol generating material, wherein the article is dimensioned to be at least partially received within the receptacle.

According to another aspect of the present disclosure, there is provided a method of using the aerosol provision device of the above aspect, or any of its embodiments. The method comprises the steps of inserting the receptacle into the device chamber and rotating the receptacle to removably engage it with the device housing.

In an embodiment, the method further comprises the step of rotating the receptacle to disengage it from the device housing and removing it from the device chamber.

In a further embodiment of either of the above, the method further comprises the step of inserting a tool into the receptacle to aid the inserting, rotating and/or removing steps.

According to another aspect of the present disclosure, there is provided another aerosol provision device. The device comprises a device housing defining a device chamber and a heater assembly. The heater assembly comprises a receptacle defining a heating chamber arranged to removably receive at least a portion of an article comprising aerosol generating material, and a heating element for heating at least a portion of an article comprising aerosol generating material received in the heating chamber. The receptacle is removably disposed within the device chamber. The device further comprises a thermocouple in the device housing that is configured to be in removable thermal communication with the heating element when the heating element is disposed in with the device chamber.

In an embodiment, an intermediate member positioned such that the heating element is placed into removable thermal communication with the thermocouple via the intermediate member when the heating element is disposed in the device chamber.

In a further embodiment, the receptacle includes the intermediate member, and the intermediate member is in fixed thermal communication with the heating element and removable thermal communication with the thermocouple when the receptacle is disposed in the device housing. Alternatively, the intermediate member is positioned in the device housing, and the intermediate member is in fixed thermal communication with the thermocouple and removable thermal communication with the heating element when the heating element is disposed in the device chamber.

According to another aspect of the present disclosure, there is provided a tool for insertion into the receptacle of the device. The tool comprises a handle, an outer plurality of prongs and an inner plurality of prongs for insertion into a receptacle. The receptacle can be that of the device of the above aspect or any of its embodiments.

In any embodiment, the inner and outer prongs extend axially from the handle along the longitudinal axis of the tool and the outer prongs are concentrically arranged around inner prongs relative to a longitudinal axis of the tool.

In a further embodiment, the inner prongs extend axially further than the outer prongs.

In a further embodiment, the inner prongs define tips that flare outwardly at an angle away from the longitudinal axis. The flared tips may have an increased radial and/or axial thickness compared to the rest of the inner prongs.

In a further embodiment, the handle includes two diametrically opposed grooves around the perimeter thereof. The grooves are configured to improve handle ergonomics.

According to another aspect of the present disclosure, there is provided another aerosol provision device. The device comprises a device housing defining a device chamber and a heater assembly. The heater assembly comprises a receptacle defining a heating chamber arranged to removably receive at least a portion of an article comprising aerosol generating material, and a heating element for heating at least a portion of an article comprising aerosol generating material received in the heating chamber. The receptacle is removably disposed within the device chamber. The device further comprises a biasing member disposed in the device housing that is configured to be compressed in response to insertion of the receptacle into the device housing chamber to provide a biasing force that opposes insertion of the receptacle into the device chamber.

In an embodiment of the above aspect, the biasing member is a spring.

In a further embodiment of either of the above, the biasing member is configured such that it is compressed by a base of the receptacle in response to the insertion of the receptacle into the device chamber.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a perspective view of an example of an aerosol provision device;

FIG. 2 shows a cross-sectional front view of the aerosol provision device of FIG. 1;

FIG. 3 shows a close up of part of FIG. 2;

FIG. 4A shows a perspective view of the heater assembly in isolation from the rest of the device;

FIG. 4B shows a cross-sectional view of the heater assembly of FIG. 4A;

FIG. 5 shows a top view of the device with the heater assembly of FIGS. 4A and 4B inserted into the device housing;

FIG. 6A shows a perspective view of a tool for facilitating removal of the heater assembly of FIG. 4A from the device housing;

FIG. 6B shows a cross-sectional view of the tool of FIG. 6A being inserted into the heater assembly when using the tool to facilitate insertion or removal of the heater assembly from the device housing; and

FIG. 7 shows a bottom perspective view of the heater assembly of FIG. 4A.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

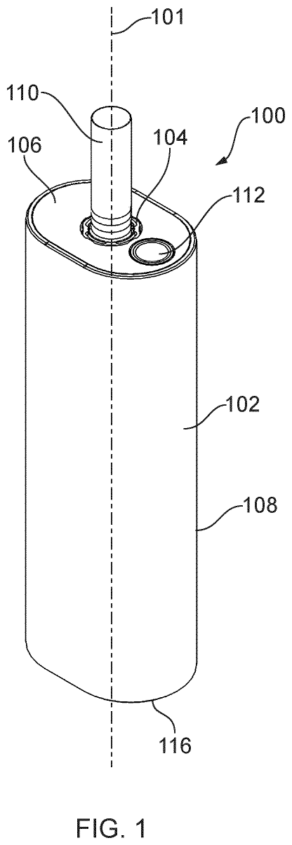

FIG. 1 shows an example of an aerosol provision device 100 for generating aerosol from an aerosol generating medium/material. In broad outline, the device 100 may be used to heat a replaceable article 110, also known as a consumable, comprising the aerosol generating medium, to generate an aerosol or other inhalable medium which is inhaled by a user of the device 100.

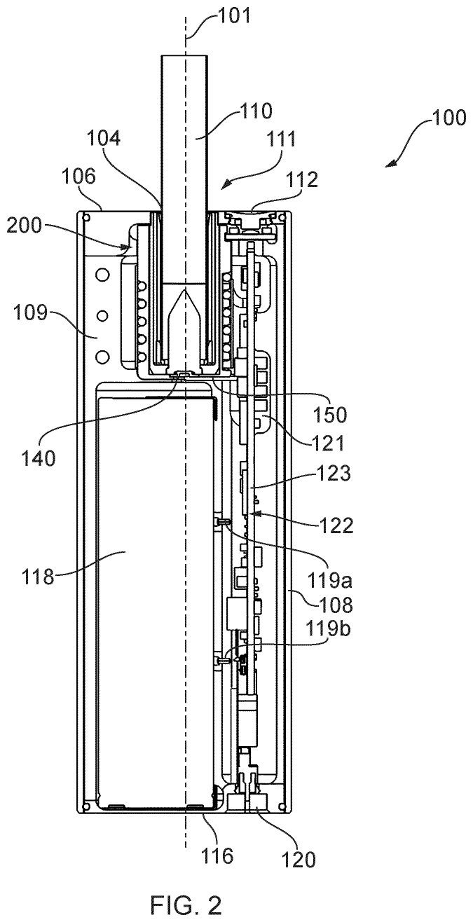

The device 100 comprises a housing 102 (including an outer cover 108) which surrounds and houses various components of the device 100. The device 100 has an opening 104 in one end, through which the article 110 may be inserted for heating by a heater assembly 200 (refer to FIG. 2). In use, the article 110 may be fully or partially inserted into the heater assembly 200 where it may be heated by one or more components of the heater assembly 200.

The device 100 may also include a user-operable control element 112, such as a button or switch, which operates the device 100 when pressed. For example, a user may turn on the device 100 by operating the switch 112.

The device 100 defines a longitudinal axis 101.

FIG. 2 depicts a schematic cross-sectional front view of the device 100 of FIG. 1. The device 100 comprises the outer cover 108, a first end member 106 and a second end member 116. The device 100 includes a chassis 109, a power source 118, and an aerosol generating assembly 111 including the heater assembly 200. The device 100 further comprises at least one electronics module 122.

The outer cover 108 forms part of a device shell. The first end member 106 is arranged at one end of the device 100 and the second end members 116 is arranged at an opposite end of the device 100. The first and second end members 106, 116 close the outer cover 108. The first and second end members 106, 116 form part of the shell. The device 100 in embodiments comprises a lid (not shown) which is moveable relative to the first end member 106 to close the opening 104 when no article 110 is in place.

The device 100 may also comprise an electrical component, such as a connector/port 120, which can receive a cable to charge a battery of the device 100. For example, the connector may be a charging port, such as a USB charging port. In some examples the connector may be used additionally or alternatively to transfer data between the device 100 and another device, such as a computing device.

The device 100 includes the chassis 109. The chassis 109 is received by the outer cover 108. The aerosol generating assembly 111 comprises the heater assembly 200 into which, in use, the article 110 may be fully or partially inserted where it may be heated by one or more components of the heater assembly 200. The aerosol generating assembly 111 and the power source 118 are mounted on the chassis 109. The chassis 109 is a one piece component.

One-piece component refers to a component of the device 100 which is not separable into two or more components following assembly of the device 100. Integrally formed relates to two or more features that are formed into a one piece component during a manufacturing stage of the component.

The first and second end members 106, 116 together at least partially define end surfaces of the device 100. For example, the bottom surface of the second end member 116 at least partially defines a bottom surface of the device 100. Edges of the outer cover 108 may also define a portion of the end surfaces. The first and second end members 116 close open ends of the outer cover 108. The second end member 116 is at one end of the chassis 109.

The end of the device 100 closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The power source 118 is, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generating assembly 111 to supply electrical power when required and under control of a controller 121 to heat the aerosol generating material.

The power source 118 and aerosol generating assembly 111 are disposed in an axial arrangement, with the power source 118 at the distal end of the device 100 and the aerosol generating assembly 111 at the proximal end of the device 100. Other configurations are anticipated.

The electronics module 122 may comprise, for example, a printed circuit board (PCB) 123. The PCB 123 may support at least one controller 121, such as a processor, and memory. The PCB 123 may also comprise one or more electrical tracks to electrically connect together various electronic components of the device 100. For example, the battery terminals 119a, 119b may be electrically connected to the PCB 123 so that power can be distributed throughout the device 100. The connector 120 may also be electrically coupled to the battery 118 via the electrical tracks.

The aerosol generating assembly 111 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

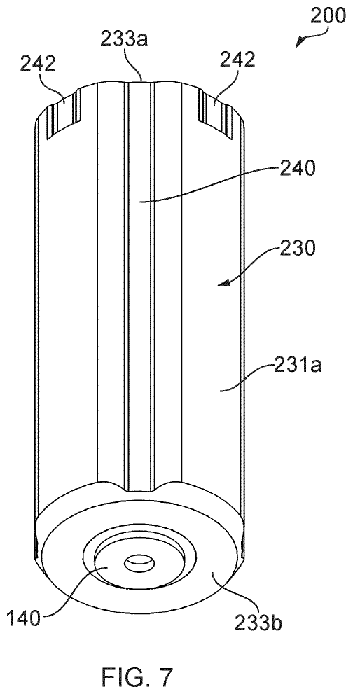

A temperature sensor in the form of a thermocouple 150 is in thermal communication with the susceptor, and is connected to the electronics module 122. In the depicted embodiment, a thermally conductive plate 140 is placed between the thermocouple 150 and the susceptor to facilitate thermal communication between the thermocouple 150 and the susceptor (as discussed in more detail below in relation to FIG. 7). In other examples, the plate 140 can be omitted.

The thermocouple 150 monitors the temperature of the susceptor during use of the device 100 and feeds this information to the electronics module 122. This allows the electronics module 122 and the controller 121 to monitor and adjust the temperature of the susceptor as may be necessary during use of the device 100, e.g. by adjusting the amount of electrical power supplied by the power source 118. The thermocouple 150 can be any suitable thermocouple, such as a platinum rhodium thermocouple (i.e. B type).

Compared to other devices for sensing temperature, the thermocouple 150 may facilitate more robust, durable, power-efficient and accurate temperature measurements. Nonetheless, in other examples within the scope of this disclosure, the temperature sensor can be any other suitable temperature sensor, such as a resistance temperature detector, thermistor, infra-red sensor etc.

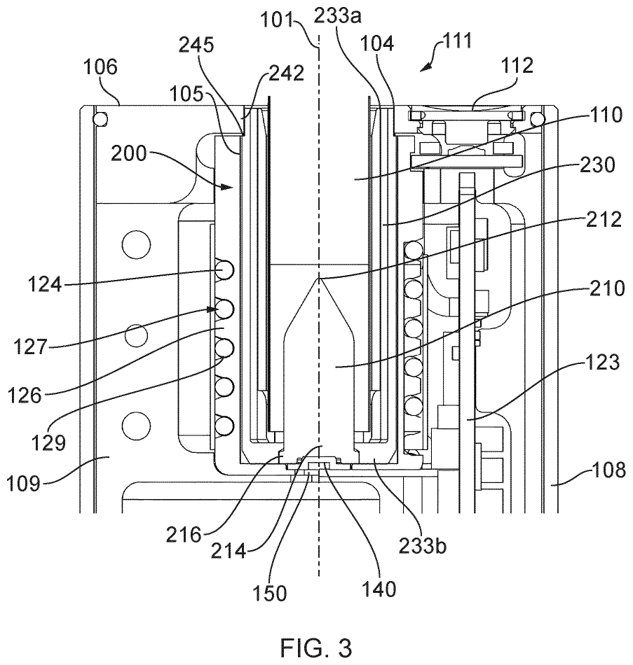

FIG. 3 shows a close up view of part of the aerosol generating assembly 111 in cross-section that includes the heater assembly 200 and an inductor coil assembly 127.

The aerosol generating assembly 111 comprises the inductor coil assembly 127 and the heater assembly 200. The inductor coil assembly 127 extends around the heater assembly 200. The inductor coil assembly 127 comprises a coil support 126. The inductor coil assembly 127 includes an inductor coil 124 wrapped around (i.e. surrounding) the heater assembly 200, disposed in a groove 129 defined in the support 126. The inductor coil assembly 127 is fixedly mounted in the device housing 102. The coil support 126 may form part of the device housing 102.

The heater assembly 200 includes a heating element 210 for heating the article 110 during use. In the exemplified embodiment of FIG. 3, the heating element is a susceptor arrangement 210 (herein referred to as “a susceptor”). The susceptor 210 of this example is a blade-shaped susceptor 210. The article 110 can be inserted onto or around the susceptor 210. The blade-shaped susceptor 210 may have a constant rectangular cross-section along the majority of its axial length and then taper to a blade tip 212. In other examples, the axial cross-section may vary along the axial length of the susceptor 210 to the blade tip 212.

Although a blade-shaped susceptor 210 is depicted, it is to be understood than any other suitable shape or form of susceptor 210 may be used within the scope of this disclosure. For example, the susceptor 210 could be pin-shaped e.g. with a constant circular cross-section along its axial length that tapers to a pin tip, or rod-shaped (e.g. a cylindrical rod or a square rod) with a constant or varying cross-section along its axial length that omits a tip or tapered portion. In further examples, the susceptor 210 may be a tubular member within which the article 110/aerosol generating material is received. Such a susceptor is an outer susceptor. In such an example, the susceptor may define a peripheral wall (e.g. an annular wall) that defines at least part of a heating chamber within which the article 110 can be received and heated. In such an example, the susceptor surrounds the article 110, instead of the article 110 surrounding the susceptor as in the blade-shaped embodiment discussed above. It will be understood that the cross-sectional profile of the outer susceptor may be formed in a variety of profile shapes.

In further examples, multiple susceptors (e.g. two or more separate susceptors) may also be provided, and may be of differing or similar configurations (e.g. pin-shaped, blade-shaped, rod-shape or tubular-type etc.), as required.

The susceptor 210 is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may therefore be heatable by electrical resistance. The heater assembly 200 may therefore comprise electrical contacts for electrical connection with the apparatus for electrically activating the heating element by passing a flow of electrical energy through the heating element. In such embodiments, inductive coil assembly 127 can be omitted as appropriate.

The inductor coil 124 is made from an electrically conducting material. In this example, the inductor coil 124 is made from Litz wire/cable which is wound in a helical fashion to provide a helical inductor coil 124. Litz wire comprises a plurality of individual wires which are individually insulated and are twisted together to form a single wire. Litz wires are designed to reduce the skin effect losses in a conductor. In the example device 100, the inductor coil 124 is made from copper Litz wire which has a circular cross section. In other examples the Litz wire can have other shape cross sections, such as rectangular. The inductor coil 124 can be connected to the PCB 123 to control the activation of inductive heating therefrom using the electronics module 122 and switch 112.

The number of inductor coils used may also differ. For example, although the heater assembly 200 shown in FIG. 3 includes an inductor coil assembly 127 with only a single coil 124, it should be understood that the inductor coil assembly 127 can feature any number of suitable coils. Additional coils may be used to provide different heating zones with different heating characteristics for the susceptor 210 (e.g. provide different heating conditions to different areas along the axial length of the susceptor 210 and/or provide different heating conditions to the susceptor 210 at different times or for different use cases). Additional coils may also be provided to generate heating in additional susceptors that may be disposed in the heater assembly 200 (not shown).

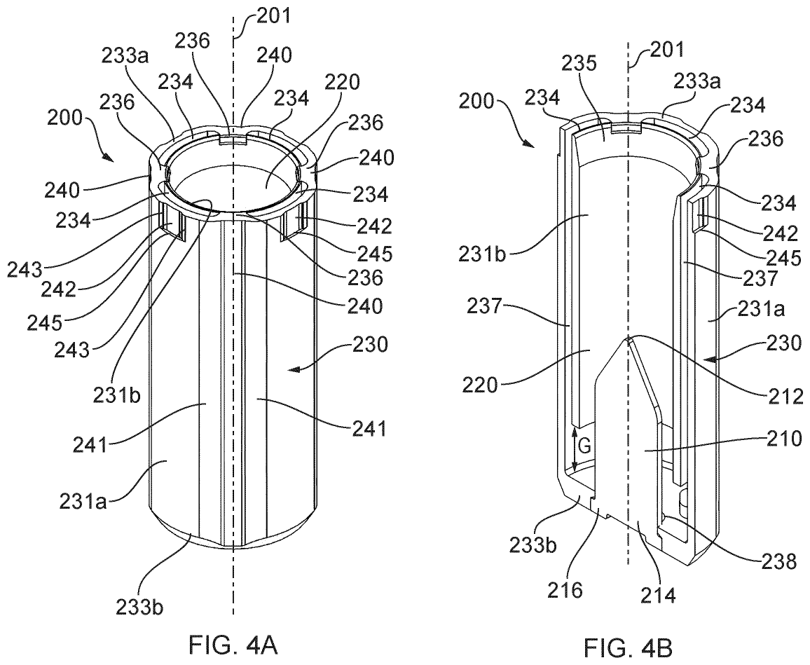

The heater assembly 200 also includes a receptacle 230 (shown in more detail in FIGS. 4A and 4B). The receptacle 230 defines a heating chamber 220 within which the article 110 is received during use. In the depicted embodiment, the receptacle 230 is an annular body that encircles the susceptor 210 and provides an annular space between the susceptor 210 and the receptacle within which the article 110 can be received and heated during use.

The coil support 126 and opening 104 define a device chamber 105 within the device housing 102 that receives the receptacle 230 and interacts therewith in order to secure the heater assembly 200 in place. In embodiments, the device chamber 105 is defined by another feature other than the coil support 126. The coil support 105 forms an internal wall. The internal wall is cup shaped.

The receptacle 230 is removably disposed within the chamber 105, such that it can be removed therefrom and replaced therein during use. This feature facilitates the cleaning of the receptacle 230 (and other heater assembly components part thereof), as well as replacement of the receptacle 230 (and other heater assembly components part thereof) in the event of breakage or failure.

In the depicted example, the receptacle 230 is completely disposed inside the chamber 105. In other examples, when the receptacle 230 is received in the chamber 105 a portion of the receptacle 230 (e.g. such as a lip or a flange at its proximal end) may still extend outside of the device chamber 105. In such examples, the receptacle 230 may therefore be ‘partially removably disposed’ in the chamber 105. This disclosure covers all such examples.

FIGS. 4A and 4B show the heater assembly 200 and the receptacle 230 in more detail. The receptacle 230 includes annular outer and inner walls 231a, 231b that are concentric with each other about the longitudinal axis 201 of the heater assembly 200. The outer wall 231a forms an outer shell. The inner wall 231b forms an inner shell. As shown in FIGS. 2 and 3, when the heater assembly 200 is inserted into the device housing chamber 205, the longitudinal axis 201 of the heater assembly 200 is substantially co-axial with the longitudinal axis 101 of the device 101.

The outer wall 231a extends axially from an opening/inlet end 233a to an opposing base 233b of the receptacle 230. The outer wall 231a may define the base 233b itself, and be integrally formed therewith. Alternatively, the base 233b could be attached to the outer wall 231a separately. The outer wall 231a forms a cup. The opening/inlet end 233a is so called, because it is the end of the heater assembly 200 that sits in the inlet 104 of the device 100 when the receptacle is inserted into the device housing chamber 105. Accordingly, as discussed above in relation to the device 100, the opening/inlet end 233a may also be referred to as the proximal end (or mouth end) of the heater assembly 200, whilst the base 233b may be referred to as the distal end of the heater assembly 200.

The base 233b defines an aperture 238 therein within which the heating element 210 is received and protrudes (axially) therefrom. The heating element 210 defines a base 214 and an anchoring flange 216 around the base 214 that is received in the aperture 238. The anchoring flange 216 and base 214 may be press-fit into the aperture 218. However, any other suitable method of securing the heating element 210 in place in the receptacle 230 may be used e.g. insert molding, interference fit, threaded fitment etc. In embodiments, aperture 238 could instead be a blind cavity/recess or may be omitted completely depending on the securing method used to attached the heating element 210 in place in the receptacle 230.

In the depicted embodiment, the heating element 210 is fixedly attached to the receptacle 230, such that it is a part of the receptacle 230 itself and is supported thereby. In this manner, the heating element 210 is removable from the device housing chamber 105, with and as part of the receptacle 230.

In alternative embodiments, the heating element 210 may instead be fixedly attached to the device housing 102 within the device housing chamber 105, instead of the receptacle 230. In this manner, whilst the receptacle 230 is removed from the device housing chamber 105 the heating element 210 will remain fixed in place within the device housing chamber 105.

In either of the above alternatives, the heating element 210 may additionally be separately removable from the device housing 102 and/or the receptacle 230 itself. For example, the heating element 210 could be removably fixed to either of the receptacle 230 or the device housing 102/chamber 105 instead of fixedly attached thereto. For example, by being threadably received therein, being received by a bayonet fitting therein, or using connectors on the heating element 210 that interference fit with corresponding connectors on the device housing 102/chamber 105, and which can be pulled apart.

This may facilitate cleaning and/or replacement of the heating element 210. This improvement in replacement of the heating element 210 may be useful in the event that the heating element 210 is broken or has failed and needs to be replaced, but may also be useful for interchanging different heating elements 210 for different use cases. For example, when a certain use case or article 110 may demand a different shape/type of heating element 210 to another.

The inner wall 231b extends axially from the proximal end 233a towards the base 233b but does not connect to the base 233b. The inner wall 231b stops axially short of the base 233b to form an axial gap G between the inner wall 231b and the base 233b. In the depicted example, the axial gap G provides an annular gap around the heating element 210 between the base 233b and the inner wall 231b.

The inner wall 231b features a tapered surface 235 at the proximal end 233a. The tapered surface 235 tapers at an angle towards the longitudinal axial 201 from the proximal end 231b. The tapered surface 235 may help facilitate insertion of the article 110 into the heater assembly 200 and heating chamber 220. For example, it may facilitate correct alignment of the article 110 when it is insert into the heating chamber 220 around the heating element 210.

The outer wall 231a and inner wall 231b are spaced radially apart and connected by radially extending ribs 236. The ribs 236 secure the inner wall 231b in place within the outer wall 231a. There are a discrete number of ribs 236 disposed between the outer and inner walls 231a, 231b around the circumference of the walls 231a, 231b. In the illustrated example, there are four such ribs 236 spaced equally around the circumference of the walls 231a, 231b. However, any suitable number and spacing of ribs 236 can be used.

In the depicted embodiment, the ribs 236 extend axially the length of the inner wall 231b. However, the ribs 236 may extend any suitable axial distance between the walls 231a, 231b that is sufficient to provide the required support for holding the walls 231a, 231b concentrically in place relative to each other.

The combination of the outer wall 231a, inner wall 231b and ribs 236 define slots 234 at the proximal end 233a and form passages 237 that extend axially within the receptacle 230.

The number and size of slots 234 and passages 237 can be varied as necessary depending on the size, spacing and number of ribs 236. Moreover, the slots 234 and passages 237 needn't be defined at the proximal end 233a. For example, the ribs 236 could be present at any suitable axial location within the receptacle 230, e.g. nearer the base 233b or midway along the axial length of the walls 231a, 231b. Moreover, the slots 234 and passages 237 could instead provide a single (e.g. substantially annular) slot 234/passage 237 that extends axially between the inner and outer walls 231a, 231b.

In the depicted embodiment, the passages 237 are used as airflow passages that permit the communication of airflow from the exterior of the device 100 to the heating chamber 220 and the aerosol generating materials therein during use. The inlet of airflow from the proximal end 233a via slots 234 and passages 237 is convenient, as the user is unlikely to block airflow to such a region when using the device 100.

The passages 237 exit into the annular space provided by gap G, which in use allows airflow to be communicated from the passages 237 into the heating chamber 220, and through the aerosol generating material/article 110 therein.

The presence of passages 237 between the inner and outer walls 231a, 231b can allow for improved control of the airflow and resistance to airflow through the passages 237. For example, it may allow the use of airflow modifying features (e.g. airflow constrictors) to be placed in the passages 237 (e.g. extending between walls 231a, 231b and/or from ribs 236) in order to provide a more consistent airflow and/or desirable airflow resistance to be communicated through the article 110 and to the user in use.

It is to be understood, however, that this disclosure is not to be limited to passages 237 being necessarily airflow passages. For example, the device 100 and/or heater assembly 200 could provide any suitable alternative or additional arrangement of airflow passages for supplying the necessary airflow for use of the device 100. For example, airflow passage(s) could be provided in the side of the device, or defined between the inner wall 231b and the article 110 itself. Airflow passage(s) could also be directed from the distal end of the device 100 and up through the base 233b instead or in addition.

The outer and inner wall 231a, 231b configuration of the receptacle 230 can facilitate improvements in the amount of insulation provided between the heating element 210 and the device housing 102 (e.g. compared to a single-walled receptacle 230). Also, if the passages 237 are used as airflow passages as discussed above, this may facilitate yet further improvement in the amount of insulation provided between the heating element 210 and the device housing 102 (e.g. as the (relatively cool external) airflow can absorb excess heat from the inner and outer walls 231a, 231b). The amount of insulation provided by the heater assembly 200 can be an important consideration for the device 100, as it may be necessary to prevent the device 100 becoming too hot in the user's hand or the temperatures becoming troublesome for other device components. By providing an air gap in the receptacle 230, it is possible to facilitate an improvement in the amount of insulation required in the device housing, leading to a compact device housing.

As discussed in passing above, the receptacle 230 is removably disposed within the chamber 105, such that it can be removed therefrom and replaced therein during use. In particular, in the depicted embodiments, the receptacle 230 is configured to interact with the chamber 105 in such a way that rotation of the receptacle 230 relative to the device housing 102 allows it to be engaged and disengaged in response to rotation of the receptacle 230.

The receptacle 230 and the device housing 102 include complementary interlocking features that are configured to engage or disengage in response to rotation of the receptacle 230 relative to the device housing 102.

Within the context of this disclosure, it should be understood that ‘engage’ relates to an engagement that holds the receptacle 230 in place sufficiently in the device housing 102 for use of the device 100, and ‘disengage’ relates to the releasing of such an engagement that allows the receptacle 230 to be removed from the device housing 102 (e.g. without having to remove other components of the device housing 102 or destroying parts of the device housing 102).

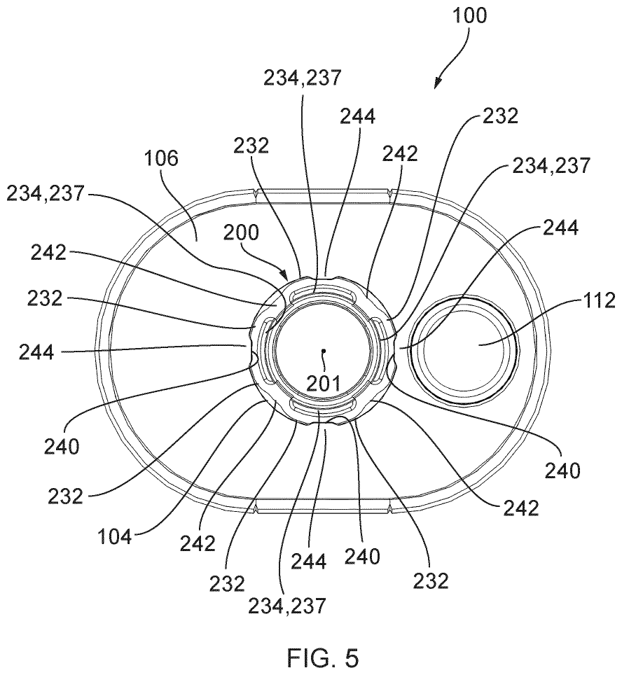

As shown in FIGS. 4A, 4B and 5, the complementary interlocking features are provided by grooves 240, 242 (or recesses) on an outer surface 232 of the receptacle 230 (i.e. radially outward facing surface of the outer wall 231a) and corresponding protrusions 244 on the device housing 102. The protrusions 244 extend radially inward from an inner surface of the device housing chamber 105 relative to the longitudinal axis 101 of the device 100.

As best shown in FIG. 5, when the heater assembly 200 is inserted into the device housing chamber 105 it is done so with the protrusion 244 radially aligned with the groove 240 (i.e. relative to longitudinal axis 201). Protrusion 244 and groove 240 are sized such that the protrusion 244 does not ‘engage’ (as discussed above) the receptacle 230 when inserted in the groove 240.

When the heater assembly 200 is subsequently rotated about the longitudinal axis 201 relative to the device housing 105, the protrusion 244 is rotated out of radial alignment with groove 240, across the outer surface 232, and into radial alignment with groove 242. Protrusion 244 and groove 242 are sized and shaped such that the protrusion 244 ‘engages’ the receptacle 230 when inserted in the groove 242. This engagement can be provided by a sufficient interference fit/contact being made between the protrusion 244 and groove 242. For example, the grooves 242 define a ridge 245 that extends radially from the groove 242 to meet the outer surface 232. When the protrusions 244 are aligned in the grooves 242 they are axially above the ridge 245 and radially overlap the ridge 245. If the receptacle 230 should try to be removed from the device housing chamber 105 with the protrusion 244 in this position (e.g. pulled out from the chamber 105 along the longitudinal axis 101), the ridge 245 will provide interfering contact with the protrusion 244 to prevent its removal.

It will be understood that subsequently rotating the receptacle 230 out of radial alignment with the groove 242/ridge 245 and back into radial alignment with the groove 240 will result in the receptacle 230 being ‘disengaged’ from the protrusion 244 and thus the device housing 102. This allows subsequent removal of the receptacle 230 from the chamber 105 and device housing 102.

The grooves 240, 242 can feature tapered/contoured surfaces 241, 243 which, along with the outer surface 232 and the protrusions 244, can be shaped/contoured as required to provide a particular resistance to rotation between grooves 240, 242. Moreover, the shape, (radial) depth and (axial) height of the grooves 242 and corresponding (radial and axial) lengths of the protrusion 244 can also be used to vary the degree of engagement between the receptacle 230 and the device housing 102 (e.g. by adjusting the degree of the interference fit/contact between the protrusion 244 and grooves 242 and ridges 245 in the engaged position) and associated resistance to rotation provided thereby.

Tailoring the resistance to rotation and degree of engagement in this manner can not only be used to ensure the heater assembly 200 is sufficiently held in the engaged position for use, but that it is also easy enough to rotate to the disengaged position to facilitate removal. Tailoring of these features can also be used to improve the user's perceived ‘smoothness’ and/or ‘quality’ of the rotation and removal process of the heater assembly 200.

Although four sets of grooves 240, 242 and protrusions 244 are shown spaced around the circumference of the chamber 105 and the heater assembly 200, any suitable number and spacing could be used within the scope of this disclosure.

In the depicted example, the grooves 240 extend the full axial length of the outer wall 231a (i.e. from proximal end 233a to base 233b). This can facilitate ensuring the correct axial and radial alignment of the heater assembly 200 during insertion into the device housing 102, as protrusions 244 can be easily aligned and guided along the grooves 240 during the insertion process.

The grooves 240 are also shown radially aligned with the ribs 236 relative to the longitudinal axis 202. This may give the grooves 240 additional structural support to resist bending during insertion of the heater assembly 200. However, the grooves 240 need not be placed in such a position, and can be positioned any other suitable radial position.

The protrusions 244 and grooves 242 are depicted at the inlet 104 and the proximal end 231a. However, within the scope of this disclosure the protrusions 244 and/or grooves 242 can be placed at any suitable axial position within the chamber 105 and along the outer surface 232, respectively. The axial length and positioning of the grooves 240 can also be varied accordingly.

Although in the depicted example the grooves 240, 242 are disposed on the receptacle 230 and the protrusions 244 disposed on the device housing 102, within the scope of this disclosure, the grooves 240, 242 could alternatively be disposed on the device housing 102 (i.e. in the chamber 105) and the protrusions 244 disposed on the receptacle 230 instead.

Although one particular set of complementary interlocking features to achieve the removable rotation engagement between the receptacle 230 and the device housing 102 in the form of grooves 240, 242 and protrusions 246 has been depicted and explained above, the present disclosure extends to any other suitable implementation of such rotational complementary interlocking features.

In one example, the complementary interlocking features could be complementary threaded portions disposed on the receptacle 230 (e.g. on the outer surface 232) and within the chamber 105. In such an example, the receptacle 230 could be screwed into and out of engagement with the device housing 102 via rotation thereof relative to the device housing 102.

In another example, the complementary interlocking features could provide a bayonet fitting type rotational engagement. In such an example, the receptacle 230 could feature radially extending pins on the outer surface 232 that can be received in corresponding L-shaped slots or recesses provided in the chamber 105. Alignment and rotation of the pins in the L-shaped slots would secure them in place to ‘engage’ the receptacle 203 to the device housing 102 (commonly known as a bayonet fitting). The L-shaped slots and pins could also alternatively be provided on the receptacle 230 and chamber 105, respectively, instead.

As touched on above, it is thought that the removeable rotational engagement between the receptacle 230 and the device housing 102 provided in this disclosure may facilitate an improved way of removing and replacing the receptacle 230 in the device 100.

It can provide a convenient and potentially more ‘satisfying’ way for the user to engage the receptacle 230 into device housing 102 and disengage it again. Moreover, the necessary alignment needed between complementary interlocking features in such a rotational engagement configuration facilitates ensuring the correct and proper alignment of the receptacle 230 in the device housing 102 for use. This may reduce user frustration and/or potential breakages of the device 100 and/or receptacle 230 when the user inserts and replaces the receptacle 230 in the device 100.

In any of the above discussed examples, a biasing member, such as a spring (not shown), could be disposed within the chamber 105/device housing 102. The biasing member can be configured to be compressed in response to insertion of the receptacle 230 into the device housing chamber 105 (e.g. by the base 233b) to provide a biasing force that opposes the insertion (but that does not override the engagement, when the receptacle 230 is placed into the engaged position within the housing 102).

Although the biasing member in the examples discussed above is used in tandem with a rotational engagement between the receptacle 230 and the device housing 102, it should be understood that within the scope of this disclosure, the biasing member can also be used in other examples that feature any other suitable type of removable engagement between the receptacle 230 and the device housing 102 (e.g. a linear/axial mode of removable engagement, a push-button removable engagement etc.).

The biasing member and biasing force it provides may be used to facilitate subsequent removal of the receptacle 230 from the housing 102 as it may help urge the receptacle 230 out of the chamber 105 when it is disengaged from the housing 102. It may also help provide suitable resistance to insertion of the receptacle 230 into the housing 102 to improve the user's perceived ‘smoothness’ and/or ‘quality’ of the insertion and removal process of the receptacle 230.

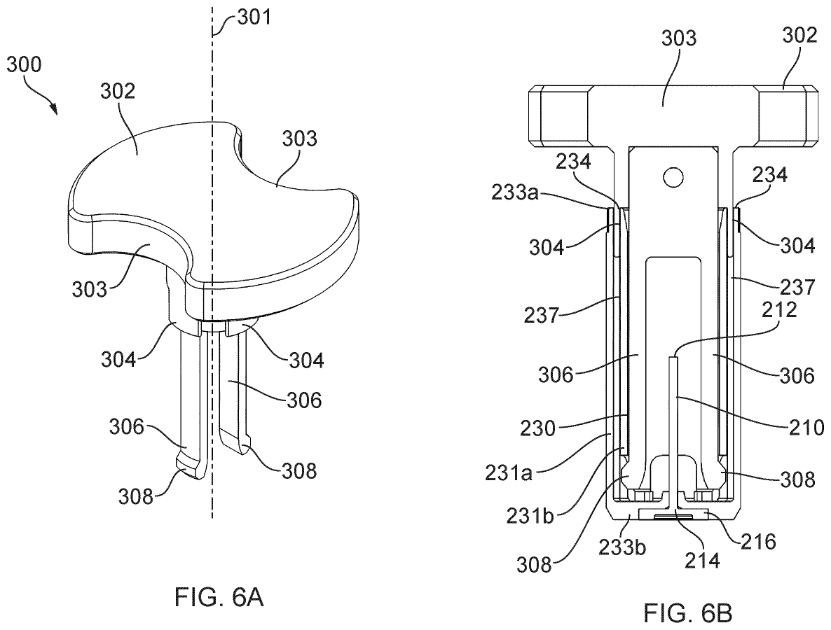

FIG. 6A shows a tool 300 that can be used in combination with the receptacle 230 to aid insertion, rotation and removal of the receptacle 230 from the device housing chamber 105.

The tool 300 may be provided as part of a kit of parts containing the device 100 and the tool 300. The kit of parts could also optionally include one or more articles 110 for use with the device 100.

The tool 300 includes a handle 302, an outer plurality of prongs 304 and an inner plurality prongs 306. The outer prongs 304 are concentrically arranged around inner prongs 306 relative to a longitudinal axis 301 of the tool 300. The inner and outer prongs 304, 306 also extend axially from the handle 302 along the longitudinal axis 301 of the tool 300.

The inner prongs 306 extend axially beyond the outer prongs 304 and define tips 308 that flare outwardly at an angle away from the longitudinal axis. Flared tips 308 may also have an increased (radial and axial) thickness compared to the rest of the inner prongs 306.

Handle 302 may include cut-outs or grooves 303 that are configured to improve the ergonomics of the handle 302 and facilitate making the handle 302 easier to grip and turn using a user's hand.

As shown in FIG. 6B, the outer and inner prongs 304, 306 are configured to extend axially into the receptacle 230 to facilitate insertion and removal of the receptacle 230 into the device housing 102.

The outer prongs 304 are sized and shaped to be received in corresponding engagement features, which in the depicted example are slots 234 that project axially into the corresponding passages 237. These features may allow for frictional or interfering contact to be made between the prongs 304 and outer and inner walls 231a, 231b.

The inner prongs 306 extend axially into the heating chamber 220 between the inner wall 231b and the heating element 210, and may be sized and shaped to provide frictional or interfering contact between the prongs 306 and the inner wall 231b.

The inner prong tips 308 are sized and shaped to flare outwardly into the gap G between the inner wall 231b and the base 233b. The flared tips 308 may also make interfering or frictional contact with the outer wall 231a and/or inner wall 231b on insertion of the tool 300 into the receptacle 230 depending on the degree of flaring/particular shape of the tips 308.

When the tool 300 is inserted into the receptacle 230 the various interfering or frictional contacts between the prongs 304, 306 and the receptacle 230 will allow the receptacle 230 to be picked up and positioned using the tool 300 (i.e. the interfering or frictional contacts are sufficient to hold the receptacle 230 on the tool prongs 304, 306 when suspended under its own weight).

Additionally or alternatively, the action of gravity on the receptacle 230 when it is suspended on the tool 300 may force the inner wall 231b into contact with the tips 308, which can hold the receptacle 230 in place due to their flared shape.

Once the tool 300 has been used to insert the receptacle 230 into the device housing 102, the handle 302 can be used to give the user improved grip and/or leverage for rotation of the receptacle 230 into engagement and out of engagement with the device housing 102.

The tool 300 allows and facilitates easier removal of the receptacle 230 from the device housing 102, as it facilitates gripping the receptacle 230 whilst it is positioned in the chamber 105. It can also facilitates cleaner removal, as the user may not need to touch the receptacle 230 itself when removing it, which may prevent them touching any aerosol generating materials or other contaminants that may have built up therein during use.

In the depicted example, there are four outer prongs 304 to correspond with each of the slots 234 and passages 237, and there are two inner prongs 306. It is to be understood, however, that any suitable number of outer and inner prongs 304, 306 could be used, e.g. depending on the specific configuration of the receptacle 230.

Moreover, there needn't be an inner and outer set of prongs, and in other examples within the scope of this disclosure, the tool 300 may include only one of the inner or the outer prongs 304, 306. In further examples, tips 308 may also be provided on the outer prongs 304 in addition to or as an alternative to being provided on the inner prongs 306.

Within the scope of this disclosure, the specific arrangement of prongs can course vary greatly depending on the specific configuration of the receptacle 230 and the degree of interference/frictional contact necessary therewith to hold it under its own weight on the tool 300.

In the depicted example, the slots 234 and passages 237 have the dual function of providing airflow passages 237 for airflow to the heating chamber 220 from the exterior of the device 100 and for insertion of the tool prongs 304 therein. However, in other examples, where alternative airflow passages are present in the device 100, the slots 234 and passages 237 may not be used for airflow, but may still be provided as appropriate for the function of allowing for insertion of the tool 300 therein.

FIG. 7 shows a bottom perspective of the receptacle 230, which includes a plate 140 fixedly attached thereto and part thereof. Plate 140 is fixedly attached to the base 233b in any suitable manner, for example, via a press fit or weld.

In the depicted example, the plate 140 is placed into thermal communication with the base 214 of the heating element 210 by making contact therewith.

Plate 140 can be made of any suitable thermally conductive material, such as a metal or alloy. In this manner, heat from the heating element 210 is communicated to the plate 140 via conduction.

The thermocouple 150 is positioned in the bottom of the device housing chamber (i.e. distal end of the chamber 105). When the receptacle 230 is inserted in the device housing chamber 105 and engaged therewith the plate 140 positioned on the base 233b will make contact with the thermocouple 150. This places the plate 140, and thus the heating element 210, into thermal communication with the thermocouple 150, which allows the thermocouple 150 to monitor the temperature of the heating element 210 during use as discussed above in relation to FIG. 2.

Although in the depicted example the plate 140 is fixedly attached to/part of the receptacle 230, in other examples, the plate 140 could instead be attached to the thermocouple 150 inside the device chamber 105 as part of the device housing 102. In such an example, the heating element base 214 would be exposed in the base 233b of the receptacle 230. Thus, the heating element base 214 would be placed into contact with the plate 140 in response to insertion of the receptacle 230 into the chamber 105 to provide the necessary thermal communication between the thermocouple 150 and the heating element 210.

In examples where the heating element 210 is additionally separately removable from the device housing 102, the plate 140 can be fixedly attached to/part of the device housing 102 and in thermal communication with the thermocouple 150. In further examples where the heating element 210 is additionally separately removable from the receptacle 230, the plate 140 can either be fixedly attached to/part of the heating element 210, the receptacle 230 or the device housing 102.

In such examples, the heating element 210 can still be placed into thermal communication with the plate 140 and thermocouple 150 following its insertion into and engagement with the housing 102 or receptacle 230.

In any of the above examples, the plate 140 may be substituted or added to with any other suitable intermediate member and shape thereof (e.g. a ring or a pin-type connector). In one such example, the intermediate member could instead be a pin that protrudes inside the heating element 210.

Indeed any combination/number of intermediate members that are suitable to provide thermal communication between the heating element 210 and the thermocouple 150 when the receptacle 130/heating element 210 is inserted and engaged with the device housing 102/chamber 105 could be used within the scope of this disclosure.

Also, any other suitable means of providing thermal communication between the heating element 210 and the thermocouple 150 when the receptacle 130/heating element 210 is inserted and engaged with the device housing 102/chamber 105 is envisaged within the scope of this disclosure.

In further examples, a thermally conductive compound, such as a thermal paste, could additionally be used in combination with the heating element 210 and/or intermediate member(s) to facilitate good conduction of temperature between the heating element 210, intermediate member(s), and the thermocouple 150, where necessary.

It will be understood that in all the examples discussed above, the described configurations permit the heating element 210 to make thermal communication with the thermocouple 150 in response to insertion of the heating element 210 into engagement with the chamber 105.

This may be said to provide ‘removable thermal communication’ between the heating element 210 and the thermocouple 150 in response to insertion of the heating element 210 into engagement with the chamber 105.

In other examples where the heating element 210 is instead fixedly attached to the device housing 102 within the device housing chamber 105 (instead of the receptacle 230), the thermocouple 150 may be attached to the heating element 210 directly, or via the plate 140 or other suitable intermediate member(s) in order to provide thermal communication therewith.

In all the above examples, thermal communication between the thermocouple 150 and the heating element 210 can be maintained, whilst keeping the thermocouple 150 separate and isolated from any aerosol generating materials or contaminants that may be present/build up in the heating chamber 220. This may facilitate improvements in the durability and longevity of the thermocouple 150 and its ability to monitor the temperature of the heating element 210. Moreover, the plate 140 (or other suitable intermediate member(s)) may still permit removability of the receptacle 130 and/or heating element 210 to facilitate improved cleaning/replaceability of these components without compromising the functionality/durability of the thermocouple 150.

It should be noted that the aforementioned examples and thermocouple solutions thereof may be equally suitable to an aerosol provision device in which the receptacle is generally removable from the housing thereof. Accordingly, the above examples and thermocouple solutions thereof need not be limited to the rotational removable configurations of the depicted receptacle 230 and device housing 102, and could be used in any other examples where the receptacle is removable from the device housing within the scope of this disclosure.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device comprising:
a device housing defining a device chamber; and
a heater assembly comprising:
a receptacle defining a heating chamber arranged to removably receive at least a portion of an article comprising aerosol generating material; and
a heating element for heating at least a portion of an article comprising aerosol generating material received in the heating chamber;
wherein the receptacle is at least partially removably disposed within the device chamber and is configured such that rotation of the receptacle relative to the device housing allows it to be engaged with the device housing.

2. The aerosol provision device of claim 1, wherein the device housing and the receptacle comprise complementary interlocking features that are configured to engage in response to rotation of the receptacle relative to the device housing.

3. The device of claim 2, wherein the complementary interlocking features comprise a first groove disposed on one of the device housing and the receptacle and a protrusion disposed on the other one of the device housing and the receptacle, wherein:
the receptacle is configured to engage with the device housing by the rotation placing the protrusion into alignment with the first groove; and
the receptacle is configured to disengage from the device housing by the rotation placing the protrusion out of alignment with the first groove.

4. The device of claim 3, the complementary interlocking features further comprise a second groove on one of the device housing and the receptacle, wherein:
the receptacle is configured to engage with the device housing by the rotation moving the protrusion out of alignment with the second groove and into alignment with the first groove; and
the receptacle is configured to disengage from the device housing by the rotation moving the protrusion out of alignment with the first groove and into alignment with the second groove.

5. (canceled)

6. The device of claim 2, wherein the complementary interlocking features are at least one of a bayonet mount and threaded portions defined on the device housing and the receptacle.

7. (canceled)

8. The device of claim 1, further comprising a biasing member that is configured to be compressed in response to insertion of the receptacle into the device housing chamber to provide a biasing force that opposes the insertion.

9. The aerosol provision device of claim 1, wherein the receptacle defines a base, and the heating element protrudes from the base.

10. The aerosol provision device of claim 1, wherein the heating element is supported by the receptacle such that the heating element is removable from the device housing by removal of the receptacle from the device housing.

11. The aerosol provision device of claim 1, wherein the heating element is supported by the device housing such that the heating element remains in the device housing following removal of the receptacle from the device housing.

12. The aerosol provision device of claim 1, wherein the heating element is separable from each of the device housing and the receptacle.

13. The aerosol provision device of claim 9, comprising a thermocouple in the device housing that is configured to be in removable thermal communication with the heating element when the heating element is disposed in the device chamber.

14. The aerosol provision device of claim 13, comprising an intermediate member positioned such that the heating element is placed into removable thermal communication with the thermocouple via the intermediate member when the heating element is disposed in the device chamber.

15. The aerosol provision device of claim 14, wherein at least one of:
the receptacle includes the intermediate member, and the intermediate member is in fixed thermal communication with the heating element and removable thermal communication with the thermocouple in response to insertion of the receptacle into engagement with the device housing; and
the intermediate member is positioned in the device housing and is in fixed thermal communication with the thermocouple and removable thermal communication with the heating element when the heating element is disposed in the device chamber.

16. The aerosol provision device of claim 1, wherein the heating element is a susceptor and the device further comprises an inductor coil for generating a varying magnetic field that penetrates the heating element.

17. The aerosol provision device of claim 1, wherein the receptacle comprises at least one engaging feature for insertion of a tool therein to aid rotation and removal of the receptacle from the device housing.

18. An aerosol provision system comprising:
an aerosol provision device according to claim 1; and
an article comprising aerosol generating material, wherein the article is dimensioned to be at least partially received within the heater assembly.

19. A kit of parts comprising:
the aerosol provision device of claim 17; and
a tool for insertion into the receptacle.

20. The kit of parts of claim 19, wherein the tool comprises a first set of prongs for engagement with the engaging feature and a second set of prongs for insertion into the heating chamber.

21-22. (canceled)

23. The kit of parts of claim 19, further comprising an article comprising aerosol generating material, wherein the article is dimensioned to be at least partially received within the receptacle.

24-26. (canceled)

27. An aerosol provision device comprising:
a device housing defining a device chamber;
a heater assembly comprising:
a receptacle defining a heating chamber arranged to removably receive at least a portion of an article comprising aerosol generating material; and
a heating element for heating at least a portion of an article comprising aerosol generating material received in the heating chamber, wherein the receptacle is removably disposed within the device chamber; and
a thermocouple in the device housing that is configured to be in removable thermal communication with the heating element when the heating element is disposed in with the device chamber.

28. The aerosol provision device of claim 27, further comprising an intermediate member positioned such that the heating element is placed into removable thermal communication with the thermocouple via the intermediate member when the heating element is disposed in the device chamber.

29-30. (canceled)
